(19) United States
(12) Patent Application Publication
(10) Pub. No.: US 2006/0158157 A1
(43) Pub. Date: Jul. 20, 2006

(54) Power control device for an electrical appliance

(76) Inventor: Chi-Wen Chen, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/104,731

(22) Filed: Apr. 12, 2005

(30) Foreign Application Priority Data
Jan. 18, 2005 (TW) 94101426

(51) Int. Cl. G05F 1/00

(52) U.S. Cl. 323/201

(57) ABSTRACT

A power control device includes a power coupler that includes a housing, a power input unit, a socket receptacle, and a control unit. The power input unit is mounted on the housing of the power coupler, and is connected electrically and removably to a commercial alternating current power source. The socket receptacle is mounted on the housing of the power coupler, and is adapted to be connected electrically and removably to an electrical appliance. The control unit is coupled between the power input unit and the socket receptacle, and is responsive to a wireless control signal for controlling electrical connection between the power input unit and the socket receptacle.

### BACKGROUND OF THE INVENTION

1. Field of the Invention

The invention relates to a power control device, more particularly to a power control device that is operable so as to selectively connect and disconnect an electrical appliance to and from a commercial alternating current power source.

2. Description of the Related Art

A conventional power control device, which is operable so as to selectively connect and disconnect an electrical appliance to and from a commercial alternating current power source, includes a housing, a first wiring that extends from the housing and that is connected electrically to a phone line, a second wiring that extends from the housing and that is connected electrically to the commercial alternating current power source, and a third wiring that extends from the housing and that is connected electrically to the electrical appliance.

Although the conventional power control device achieves its intended purpose, it is relatively difficult to install in view of the various wirings involved. As such, the installation of the conventional power control device can only be performed by trained personnel, thus resulting in high installation costs and poor movability.

### SUMMARY OF THE INVENTION

Therefore, the object of the present invention is to provide a power control device that is capable of overcoming the aforesaid drawbacks of the prior art.

According to one aspect of the present invention, a power control device comprises a power coupler that includes a housing, a power input unit, a socket receptacle, and a control unit. The power input unit is mounted on the housing of the power coupler, and is adapted to be connected electrically and removably to a commercial alternating current power source. The socket receptacle is mounted on the housing of the power coupler, and is adapted to be connected electrically and removably to an electrical appliance. The control unit is coupled between the power input unit and the socket receptacle, and is responsive to a wireless control signal for controlling electrical connection between the power input unit and the socket receptacle.

According to another aspect of the present invention, a telephone-based controller, which controls switching activity of a power coupler that controls electrical connection between a power source and an electrical appliance, comprises a housing, a phone jack, and a control circuit. The phone jack is mounted on the housing and is adapted to be connected electrically to a phone line. The control circuit is mounted in the housing, is coupled to the phone jack, and is operable so as to generate a wireless control signal that is transmitted wirelessly for reception by the power coupler and that is generated in response to a telephone communications link initiated by a calling party through the phone line. The power coupler is responsive to the wireless control signal so as to control its switching activity.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of a power control device according to the present invention;

FIG. 2 is a schematic circuit block diagram of the first preferred embodiment;

FIG. 3 is a schematic circuit diagram of a power coupler of the first preferred embodiment;

FIG. 4 is a schematic circuit diagram of a telephone-based controller of the first preferred embodiment;

FIG. 5 is a schematic circuit diagram of a remote controller of the first preferred embodiment; and

FIG. 6 is a perspective view illustrating a remote controller of a power coupler of an alternative embodiment of a power control device according to the present invention.

### DETAILED DESCRIPTION OF THE PREFERRED EMBODIMENTS

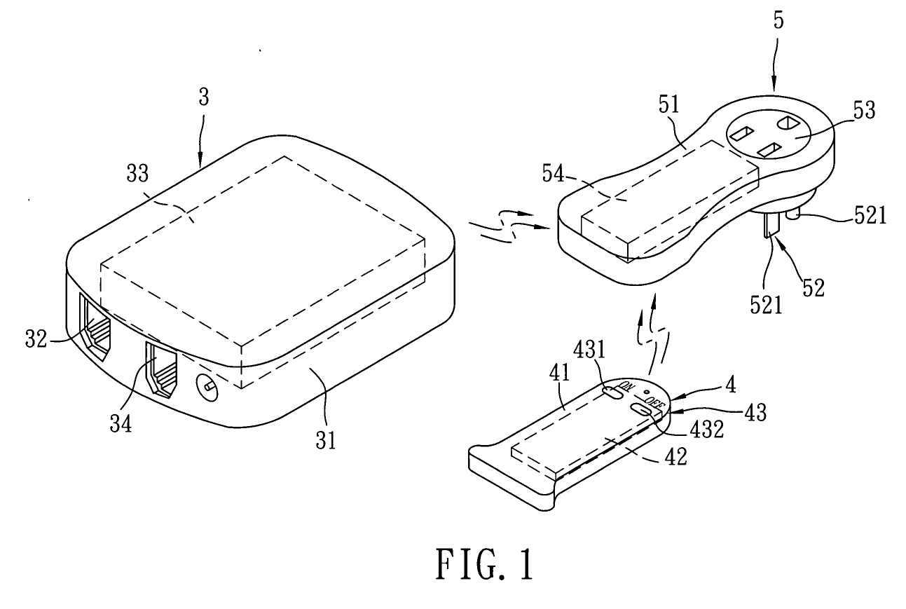

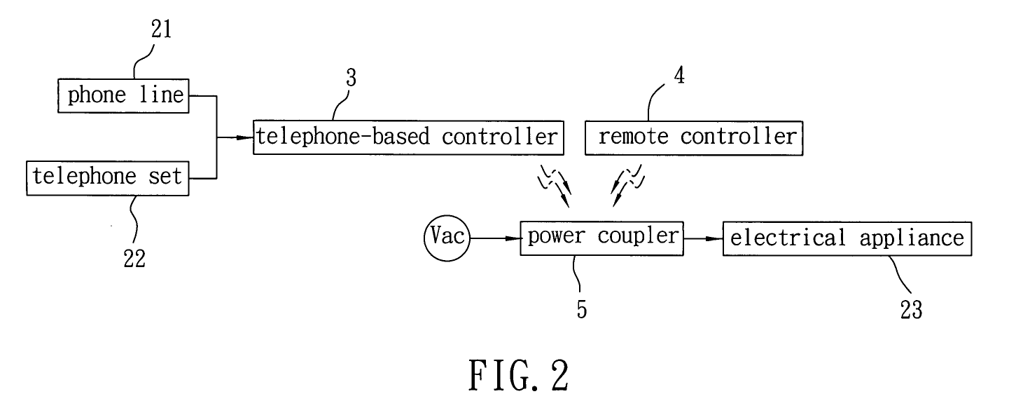

Referring to FIGS. 1 and 2, the first preferred embodiment of a power control device according to this invention is shown to include a power coupler 5 and a telephone-based controller 3.

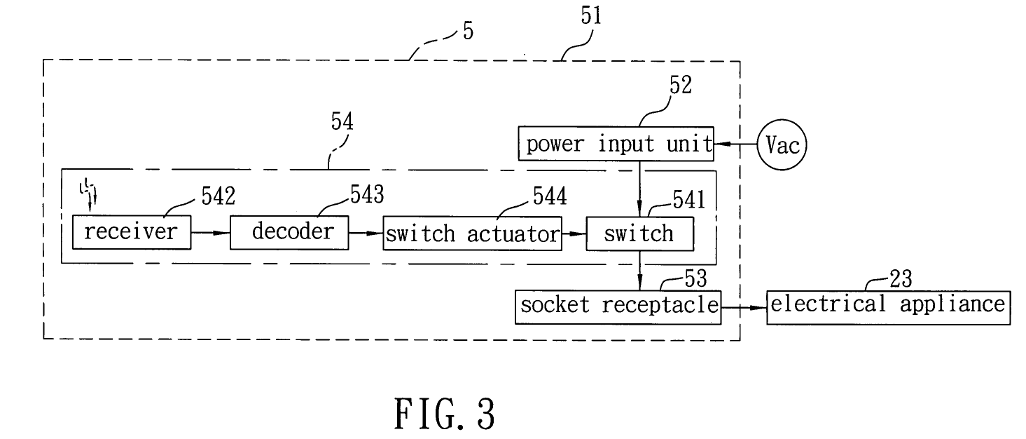

The power coupler 5 includes a housing 51, a power input unit 52, a socket receptacle 53, and a control unit 54. The housing 51 of the power coupler 5 is generally rectangular in shape. The power input unit 52 of the power coupler 5 includes a set of conductive prongs 521 that are mounted on the housing 51 of the power coupler 5, and that are connected electrically and removably to a commercial alternating current power source (Vac). The socket receptacle 53 is mounted on the housing 51 of the power coupler 5, and is connected electrically and removably to an electrical appliance 23. Although the power coupler 5 of the power control device of this invention is exemplified using only a single socket receptacle 53, it should be apparent to those skilled in the art that the number of socket receptacles may be increased as required. The control unit 54 is coupled between the conductive prongs 521 of the power input unit 52 and the socket receptacle 53 of the power coupler 5, and is responsive to a wireless control signal for controlling electrical connection between the conductive prongs 521 of the power input unit 52 and the socket receptacle 53 of the power coupler 5. In this embodiment, with further reference to FIG. 3, the control unit 54 of the power coupler 5 is mounted in the housing 51 of the power coupler 5, and includes a switch 541, a receiver 542, a switch actuator 544, and a decoder 543. The switch 541 of the control unit 54 of the power coupler 5 is coupled between the conductive prongs 521 of the power input unit 52 and the socket receptacle 53 of the power coupler 5, and is operable so as to make or break the electrical connection between the power input unit 52 and the socket receptacle 53. Preferably, the switch 541 includes a relay. The receiver 542 is operable so as to receive the wireless control signal. The switch actuator 544 of the control unit 54 of the power coupler 5 is coupled to the switch 541. The decoder 543 of the control unit 54 of the power coupler 5 is coupled between the receiver 542 and the switch actuator 544, and is operable so as to decode the wireless control signal received by the receiver 542. When the receiver 542 receives the wireless control signal, the switch actuator 544 controls actuation of the switch 541 based on a decoded output from the decoder 543.

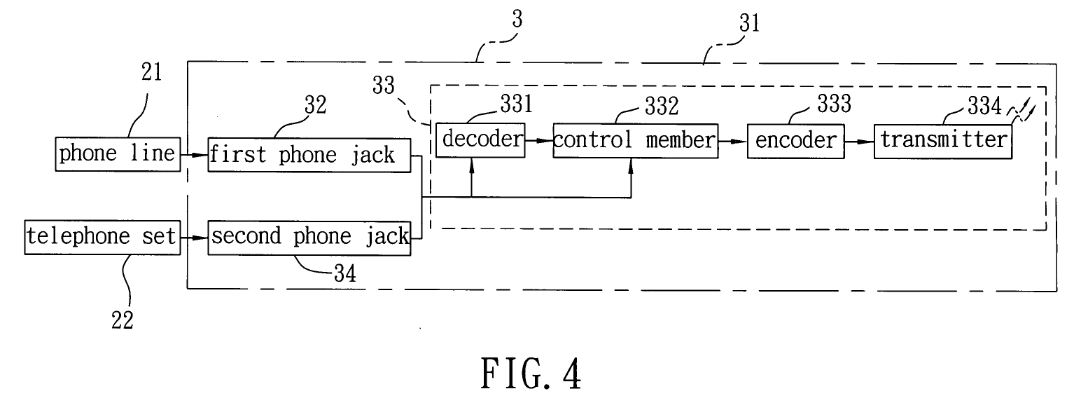

With further reference to FIG. 4, the telephone-based controller 3 includes a housing 31, a pair of first and second phone jacks 32, 34, and a control circuit 33. The housing 31 of the telephone-based controller 3 is generally rectangular in shape. The first phone jack 32 of the telephone-based controller 3 is mounted on the housing 31 of the telephone-based controller 3, and is connected electrically and removably to a phone line 21. The second phone jack 34 of the telephone-based controller 3 is mounted on the housing 31 of the telephone-based controller 3, is coupled in parallel to the first phone jack 32 of the telephone-based controller 3, and is connected electrically and removably to a telephone set 22. Although the telephone-based controller 3 of the power control device of this invention is exemplified using only a single second phone jack 34, it should be apparent to those skilled in the art that the number of second phone jacks may be increased as required. The control circuit 33 of the telephone-based controller 3 is mounted in the housing 31 of the telephone-based controller 3, is coupled to the first phone jack 32, and is operable so as to generate the wireless control signal that is transmitted wirelessly for reception by the receiver 542 of the control unit 54 of the power coupler 5 and that is generated in response to a telephone communications link initiated by a calling party (not shown) through the phone line 21. It is noted that the calling party may be using a telephone set, a wireless phone, or a cellular phone. In this embodiment, the control circuit 33 of the telephone-based controller 3 includes a decoder 331, a control member 332, an encoder 333, and a transmitter 334. The decoder 331 of the control circuit 33 of the telephone-based controller 3 is coupled to the first phone jack 32 of the telephone-based controller 3. The control member 332 of the control circuit 33 of the telephone-based controller 3 is coupled to the decoder 331 of the control circuit 33 of the telephone-based controller 3. The encoder 333 of the control circuit 33 of the telephone-based controller 3 is coupled to the control member 332 of the control circuit 33 of the telephone-based controller 3. The transmitter 334 of the control circuit 33 of the telephone-based controller 3 is coupled to the encoder 333 of the control circuit 33 of the telephone-based controller 3.

In operation, when the control circuit 33 of the telephone-based controller 3 receives a ringing signal through the phone line 21 via the first phone jack 32, i.e., the telephone-based controller 3 receives a call from the calling party, the control circuit 33 of the telephone-based controller 3 establishes a telephone communications link with the calling party through the phone line 21. It is noted that the telephone communications link is established only when the ringing signal is continuously received by the control circuit 33 of the telephone-based controller 3 within a predetermined time period, i.e., a handset (not shown) of the telephone set 22 that connected to the second phone jack 34 was not lifted within the predetermined time period. Once the telephone communications link has been established, the control circuit 33 of the telephone-based controller 3 interacts with the calling party through the telephone communications link via a pre-recorded voice message, in a manner well known in the art, thereby guiding the calling party to operate specific telephone keys for an operation intended by the calling party. Thereafter, the calling party issues a telephony signal that is received from the first phone jack 32 of the telephone-based controller 3 and that is decoded by the decoder 331 of the control circuit 33 of the telephone-based controller 3. The control member 332 the control circuit 33 of the telephone-based controller 3 then generates a control output in response to a decoded output from the decoder 331. Subsequently, the encoder 333 of the control circuit 33 of the telephone-based controller 3 encodes the control output from the control member 332 to result in the wireless control signal, which is transmitted by the transmitter 334 of the control circuit 33 of the telephone-based controller 3. At this time, when the receiver 542 of the control unit 54 of the power coupler 5 receives the wireless control signal transmitted by the transmitter 334 of the control circuit 33 of the telephone-based controller 3, the decoder 543 of the control unit 54 of the power coupler 5 decodes the wireless control signal received by the receiver 542. The switch actuator 544 of the control unit 54 of the power coupler 5 then controls actuation of the switch 541 of the control unit 54 of the power coupler 5 so as to make or break electrical connection between the conductive prongs 521 of the power input unit 51 and the socket receptacle 53 of the power coupler 5 based on the decoded output from the decoder 543.

It is noted that that the telephone set 22 may be likewise operated to issue the telephony signal.

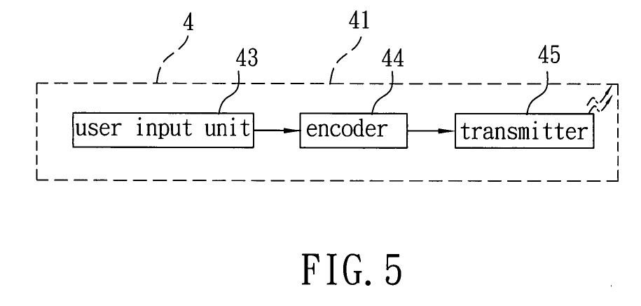

The power control device further includes a remote controller 4 that enables a user to control the power coupler 5 from a distance. In this embodiment, with further reference to FIG. 5, the remote controller 4 includes a housing 41, a user input unit 43, an encoder 44, and a transmitter 45. Preferably, the user input unit 43 includes a pair of on and off keys 431, 432 mounted on the housing 41 of the remote controller 4. The encoder 44 of the remote controller 4 is mounted in the housing 41 and is coupled to the on and off keys 431, 432 of the user input unit 43. The transmitter 45 of the remote controller 4 is mounted in the housing 41, and is coupled to the encoder 44.

In operation, when the on (off) key 431 (432) of the user input unit 43 of the remote controller 4 is pressed, the on (off) key 431 (432) of the user input unit 43 of the remote controller 4 generates a corresponding user-selected control output. The encoder 44 of the remote controller 4 then encodes the user-selected control output from the user input unit 43 of the remote controller 4 to result in the wireless control signal, which is transmitted by the transmitter 45 of the remote controller 4 for reception by the receiver 542 of the control unit 54 of the power coupler 5. At this time, when the receiver 542 of the control unit 54 of the power coupler 5 receives the wireless control signal transmitted by the transmitter 45 of the remote controller 4, the decoder 543 of the control unit 54 of the power coupler 5 decodes the wireless control signal received by the receiver 542. The switch actuator 544 of the control unit 54 of the power coupler 5 then controls actuation of the switch 541 of the control unit 54 of the power coupler 5 so as to make (break) electrical connection between the conductive prongs 521 of the power input unit 51 and the socket receptacle 53 of the power coupler 5 based on the decoded output from the decoder 543.

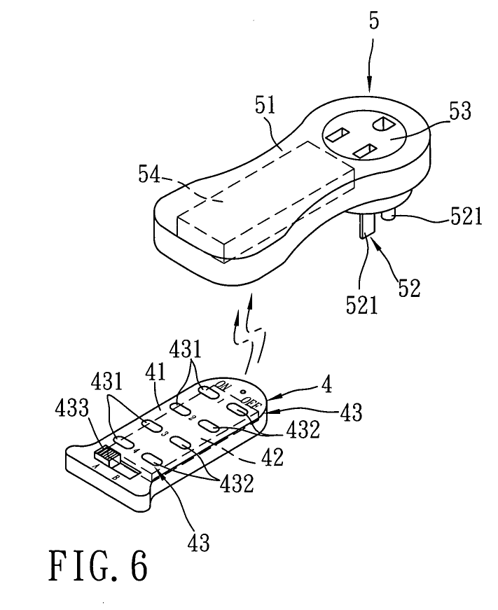

It an alternative embodiment, referring to FIG. 6, the power control device includes first and second groups of the power couplers 5. For clarity, FIG. 6 shows only one of the power couplers 5. The user input unit 43 of the remote controller 4 includes a plurality of the key sets, each of which includes a pair of the on and off keys 431, 432, and a select key 433. As illustrated in FIG. 6, the on and off keys 431, 432 of the key sets of the remote controller 4 are arranged in rows. The select key 433 of the remote controller 4 is operable so as to select one of the first and second groups of the power couplers 5. The on and off keys 431, 432 of each of the key sets of the remote controller 4 are operated to generate the wireless control signal that corresponds to one of the power couplers 5 in the first group when the first group is selected through the select key 433 of the remote controller 4. On the other hand, the on and off keys 431, 432 of each of the key sets of the remote controller 4 are operated to generate the wireless control signal that corresponds to one of the power couplers 5 in the second group when the second group is selected through the select key 433 of the remote controller 4.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A power control device comprising:
a power coupler including
a housing,
a power input unit mounted on said housing of said power coupler, and adapted to be connected electrically and removably to a commercial alternating current power source,
a socket receptacle mounted on said housing of said power coupler, and adapted to be connected electrically and removably to an electrical appliance, and
a control unit coupled between said power input unit and said socket receptacle, and responsive to a wireless control signal for controlling electrical connection between said power input unit and said socket receptacle.

2. The power control device as claimed in claim 1, wherein said power input unit includes a set of conductive prongs.

3. The power control device as claimed in claim 1, wherein said control unit includes:
a switch coupled between said power input unit and said socket receptacle, and operable so as to make or break the electrical connection between said power input unit and said socket receptacle;
a receiver mounted in said housing of said power coupler, and operable so as to receive the wireless control signal; and
a switch actuator coupled between said receiver and said switch, and operable so as to control actuation of said switch when said receiver receives the wireless control signal.

4. The power control device as claimed in claim 3, wherein said control unit further includes a decoder coupled between said receiver and said switch actuator, and operable so as to decode the wireless control signal received by said receiver, said switch actuator controlling actuation of said switch based on a decoded output from said decoder.

5. The power control device as claimed in claim 3, wherein said switch includes a relay.

6. Thepower control device as claimed in claim 1, further comprising:
a telephone-based controller including
a housing,
a first phone jack mounted on said housing of said telephone-based controller, and adapted to be connected electrically to a phone line, and
a control circuit mounted in said housing of said telephone-based controller, coupled to said first phone jack, and operable so as to generate the wireless control signal that is transmitted wirelessly for reception by said power coupler and that is generated in response to a telephone communications link initiated by a calling party through the phone line.

7. The power control device as claimed in claim 6, wherein said control circuit of said telephone-based controller is operable so as to receive a ringing signal through the phone line, establish the telephone communications link with the calling party through the phone line when the ringing signal is continuously received by said control circuit within a predetermined time period, and interact with the calling party through the telephone communications link in order to enable generation of the wireless control signal intended by the calling party.

8. The power control device as claimed in claim 6, wherein said control circuit includes:
a decoder coupled to said first phone jack and operable so as to decode a telephony signal issued by the calling party through the phone line and received by said first phone jack;
a control member coupled to said decoder and operable so as to generate a control output in response to a decoded output from said decoder;
an encoder coupled to said control member and operable so as to encode the control output from said control member to result in the wireless control signal; and
a transmitter coupled to said encoder and operable so as to transmit the wireless control signal for reception by said power coupler.

9. The power control device as claimed in claim 6, wherein said telephone-based controller further includes a second phone jack that is mounted on said housing of said telephone-based controller, that is coupled in parallel to said first phone jack, and that is adapted to be connected electrically to a telephone set.

10. The power control device as claimed in claim 1, further comprising:
a remote controller including
a housing,
a user input unit mounted on said housing of said remote controller, and operable so as to generate a user-selected control output,
an encoder mounted in said housing of said remote controller, coupled to said user input unit, and operable so as to encode the user-selected control output from said user input unit to result in the wireless control signal; and
a transmitter mounted in said housing of said remote controller, coupled to said encoder, and operable so as to transmit the wireless control signal for reception by said power coupler.

11. The power control device as claimed in claim 10, comprising a plurality of said power couplers, said user input unit including a plurality of key sets, each of said key sets being operable so as to generate the wireless control signal for a corresponding one of said power couplers.

12. The power control device as claimed in claim 10, comprising first and second groups of said power couplers, said user input unit including a plurality of key sets, each of said key sets corresponding to one of said power couplers in said first group and to one of said power couplers in said second group, said user input unit further including a select key for selecting one of said first and second groups of said power couplers,
wherein each of said key sets is operable so as to generate the wireless control signal for the corresponding one of said power couplers in said first group when said first group is selected through said select key; and
wherein each of said key sets is operable so as to generate the wireless control signal for the corresponding one of said power couplers in said second group when said second group is selected through said select key.

13. The power control device as claimed in claim 6, further comprising:
a remote controller including
a housing,
a user input unit mounted on said housing of said remote controller unit, and operable so as to generate a user-selected control output,
an encoder coupled to said user input unit, and operable so as to encode the user-selected control output from said user input unit to result in the wireless control signals; and
a transmitter mounted in said housing of said remote controller, coupled to said encoder, and operable so as to transmit the wireless control signal for reception by said power coupler;
wherein said power coupler is responsive to the wireless control signal transmitted by any one of said telephone-based controller and said remote controller.

14. A telephone-based controller for controlling switching activity of a power coupler that controls electrical connection between a power source and an electrical appliance, said telephone-based controller comprising:
a housing;
a phone jack mounted on said housing, and adapted to be connected electrically to a phone line; and
a control circuit mounted in said housing, coupled to said phone jack, and operable so as to generate a wireless control signal that is transmitted wirelessly for reception by the power coupler and that is generated in response to a telephone communications link initiated by a calling party through the phone line;
whereby the power coupler is responsive to the wireless control signal so as to control the switching activity thereof.
